(19) United States
(12) Patent Application Publication
(10) Pub. No.: US 2013/0314631 A1
(43) Pub. Date: Nov. 28, 2013

(54) PIXEL STRUCTURE OF LIQUID CRYSTAL DISPLAY UTILIZING ASYMMETRICAL DIFFRACTION

(71) Applicants: Valentin Tsvetkov, Hong Kong (CN); Vladimir Grigorievich Chigrinov, Hong Kong (CN); Hoi Sing Kwok, Hong Kong (CN)

(72) Inventors: Valentin Tsvetkov, Hong Kong (CN); Vladimir Grigorievich Chigrinov, Hong Kong (CN); Hoi Sing Kwok, Hong Kong (CN)

(73) Assignee: THE HONG KONG UNIVERSITY OF SCIENCE AND TECHNOLOGY, Hong Kong (CN)

(21) Appl. No.: 13/984,492

(22) PCT Filed: Feb. 10, 2012
(86) PCT No.: PCT/CN12/00165

§ 371 Date: Aug. 8, 2013

Related U.S. Application Data
(60) Provisional application No. 61/457,244, filed on Feb. 10, 2011.

(51) Int. Cl. G02F 1/1333

(52) U.S. Cl. CPC G02F 1/1333
USPC 349/33; 349/123; 349/124

(57) ABSTRACT

A liquid crystal (LC) pixel, a method for providing an output thereof and a liquid crystal display device are provided. The LC pixel includes: a first electrode (5) having comb-like structures; an alignment layer (6) adjacent to the first electrode (5), wherein the alignment layer (6) is patterned with local areas that are different from the remaining area of the alignment layer (6) and wherein the local areas are configured to produce local defects in initial orientation in an LC layer (1) upon application of a control voltage; and the LC layer (1), configured to asymmetrically diffract light passing through the LC layer (1) based on configuration of the comb-like structures and the alignment layer (6).

### CROSS-REFERENCE TO RELATED APPLICATIONS

This patent application claims the benefit of U.S. Provisional Patent Application No. 61/457,244, filed Feb. 10, 2011 which is incorporated by reference in its entirety.

### FIELD

The present invention relates to a configuration of color liquid crystal display (LCD) pixels, which are divided into three sub-pixels with the three basic RGB (red, green, blue) colors. Each sub-pixel modulates the intensity of one primary color separately.

### BACKGROUND

The formation of primary colors is implemented in different ways. The most common of these is that each of the three sub-pixels provides a filter, transmitting light from one of the three specific wavelengths (the 3 primary colors). The plot of the LC layer, located opposite the sub-pixels, with a polarizer adjusts the intensity of light passing through each sub-pixel. Combining the controlled voltages applied to the LC layer in the sub-pixels allows for generation of full color images.

Another way of forming the primary colors and full color images is to form the sub-pixels within a controlled diffraction grating that decomposes the passing white light into color components. Each sub-pixel includes an output mask, which allows selection of one of the three primary colors by a voltage controlled LC diffraction grating. The diffraction efficiency, and hence the intensity of the transmitted light depends on the applied voltage. Thus, the combination of control voltages applied to controllable diffraction grating in each sub-pixel can create full color images. This method allows creating vivid full-color images, but has a limited resolution.

U.S. Pat. No. 5,528,398 to Suzuki et al., issued Jun. 18, 1996, and PCT Application No. WO 85/04962, filed May 19, 1985, describe an LCD pixel containing an LC layer placed between two substrates with transparent electrodes (ITO) and orienting coverings on the inside, with a triad of optical filters passing light of one of three primary RGB wavelengths. The triad optical filters are executed from polymer and in each of them dye absorbing one of primary colors is introduced. The LC sub-pixel layer is placed after each of the optical filters and, with the help of polarizers, the quantity of light passing through each of the optical filters is regulated independently based on an applied voltage. Based on the combination of operating voltages applied to the sub-pixels, the full color image is created, including a bright white state and a totally dark black state.

The disadvantages of this display include low light transmission (the share of light that is absorbed by optical filters and polarizers is up to 95-98%) and the high cost of manufacturing of optical filters and polarizers. This cost can amount to being about 40-45% of the total cost of an entire LCD panel. There are also technological difficulties at the manufacturing stage, e.g., leveling and orienting covers, transparent electrodes on usually fusible polymer. Additionally, these processes usually require a high temperature, which is capable of damaging other layers, and the durability of the LCD pixel is limited since the LC can chemically react with polymer of an optical filter and/or with dye. This can lead to its degradation and loss of working capacity.

U.S.S.R. Patent Application No. 488177 to Tsvetkov et al., issued Jun. 10, 1976, describes a pixel of an LCD that contains an LC layer between two substrates with transparent electrodes, one of which is continuous (whole) and another which is executed in the form of combs with mutually penetrating teeth. The period of the teeth of one comb is 2d, which is located among the teeth of a second comb also having a teeth period of 2d, and the common period of the two combs is d. The element is supplied by input and output masks with slits. The positions of the slits of the input and the output masks are coordinated in such a manner that without voltage (OFF state) the light does not pass through the mask. When voltage is applied to a continuous (common) electrode and one of the combs, the LC is reoriented in the parts which are under the teeth only. The LC layer having alternating strips of LC with an initial orientation and strips of re-oriented LC represents a phase diffractive grating.

A white light passing through the slits of the input mask undergoes diffraction on the phase diffractive grating and creates a diffractive spectrum in a plane of the output mask. The output mask provides the slits through which light of a wavelength k passes. When the voltage is ON between the common and two comb-like electrodes, the LC layer creates a phase diffractive grating with a period that is twice as small, so that light with a wavelength of 2λ passes through the same slits.

This pixel provides three optically distinguishable states: DARK (the OFF state), COLOR 1, COLOR 2. Only two colors are available because only two different wavelengths can be utilized. This pixel has high operational properties: relatively high brightness due to the absence of absorbing polarizers and color optical filters, and stable colors independent of temperature or deviations of the LC thickness. The LC layer does not chemically react with the neighboring layers and, consequently, the durability of the display is relatively higher. Additionally, the price of manufacturing of such a display is also lowered due to the absence of expensive polarizes and optical filters. However, the disadvantages of this pixel are the limited set of colors (only two), which complicates the possibility of getting a wide color gamut.

Three independent primary colors, in addition to management of gray scale intensity, is needed to achieve a full color spectrum.

### SUMMARY

In an embodiment, the present invention provides a liquid crystal pixel. The liquid crystal pixel includes: a first electrode having comb-like structures; an alignment layer adjacent to the first electrode, wherein the alignment layer is patterned with local areas that are different from the remaining area of the alignment layer and wherein the local areas are configured to produce local defects in initial orientation in an LC layer upon application of a control voltage; and the LC layer, configured to asymmetrically diffract light passing through the LC layer based on configuration of the comb-like structures and the alignment layer.

In another embodiment, the present invention provides a liquid crystal display device. The liquid crystal display device includes pixels that have: an input mask with slits; a lenticular raster-condenser with foci that coincide with the slits of the input mask; a first substrate; a first electrode having comb-like structures; an alignment layer adjacent to the first electrode, wherein the alignment layer is patterned with local areas that are different from the remaining area of the alignment layer and wherein the local areas are configured to produce local defects in initial orientation in an LC layer upon application of a control voltage; the LC layer, configured to asymmetrically diffract light passing through the LC layer based on configuration of the comb-like structures and the alignment layer; a second electrode; a second substrate; a lenticular raster-objective; and an output mask with slits, wherein the position of the slits of the output mask is based on the position of the slits of the input mask. The pixels are divided into one or more sub-pixels, and the output mask is configured to transmit light from only one polarity of diffraction maxima of the diffracted light passing through the LC layer for each sub-pixel.

In yet another embodiment, the present invention provides a method for providing an output of a liquid crystal pixel having one or more sub-pixels. The method includes: receiving input light through slits of an input mask; asymmetrically diffracting the input light at an LC layer based on application of a control voltage via an electrode having comb-like structures and local defects in orientation of the LC layer produced by the application of the control voltage and local areas of an alignment layer patterned differently than the remaining area of the alignment layer; and providing the output through slits of an output mask.

### BRIEF DESCRIPTION OF THE SEVERAL VIEWS OF THE DRAWING(S)

FIG. 1a is a diagram illustrating a pixel and a path of light through the pixel in the presence of an applied voltage in accordance with an embodiment of the present invention.

FIG. 1b is a diagram illustrating an electrode of the pixel depicted in FIG. 1a

FIG. 2a is a graph depicting a wedge-like profile of refraction indices corresponding to the pixel depicted in FIG. 1a.

FIG. 2b is a graph depicting a distribution of light intensity based on the wedge-like profile of refraction indices shown in FIG. 2a.

FIG. 2c is an oscillogram depicting an experimentally obtained distribution of light intensity based on the wedge-like profile of refraction indices shown in FIG. 2a.

FIG. 3a is a graph depicting a meander-like profile of refraction indexes.

FIG. 3b is a graph depicting a distribution of light intensity based on the meander-like profile of refraction indices shown in FIG. 3a.

FIG. 3c is an oscillogram depicting an experimentally obtained distribution of light intensity based on the meander-like profile of refraction indices shown in FIG. 3a.

### DETAILED DESCRIPTION

In an embodiment, the present invention provides a pixel of a liquid crystal display (LCD), containing an input mask with slits, a lenticular raster-condenser with foci that coincide with the input slit mask, and an LC layer confined between two substrates with transparent electrodes (ITO), one of which is made in the form of strips by removing part of the electrode in the form of windows, while keeping the LC orientation layer on the substrate's inner surface. The pixel area is divided into three sub-pixels, and the pixel further includes a lenticular raster-objective and an output mask with slits. The position of the slits on the output mask is based on the position of the slit input masks to ensure the passage of one of the three primary colors in each of the sub pixels. Along the edges of windows in a transparent electrode, asymmetric deformation of the liquid crystal layer is provided by local areas of differing alignment within the strip. This leads to asymmetric diffraction and almost to an absence of diffraction maxima (peaks) on one side of the zero maximum. Consequently, the slits of the output mask can be fixed on just one side of the central axis corresponding to each sub-pixel (which corresponds to one side of the zero maximum). The resolving power is increased due to the fact that the formed asymmetric controlled diffraction grating possesses diffraction maxima (orders) located on one side of the zero order, i.e., only positive or only negative maxima.

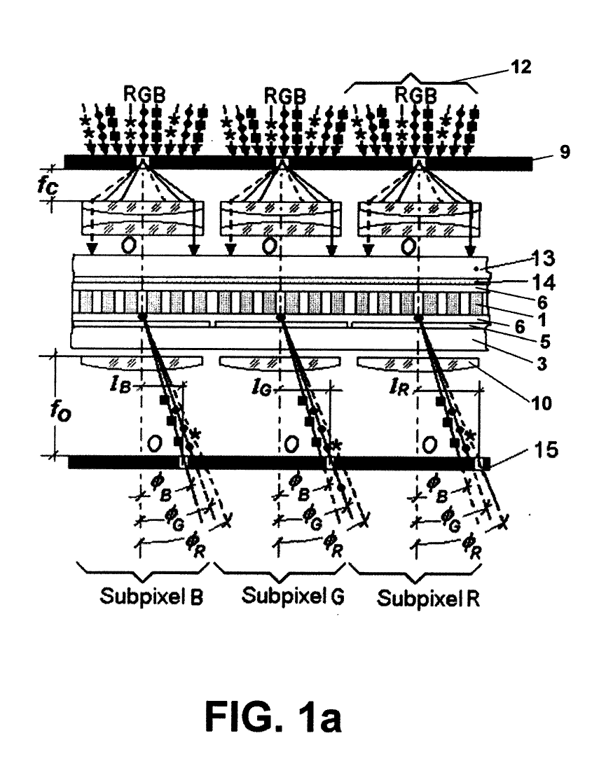

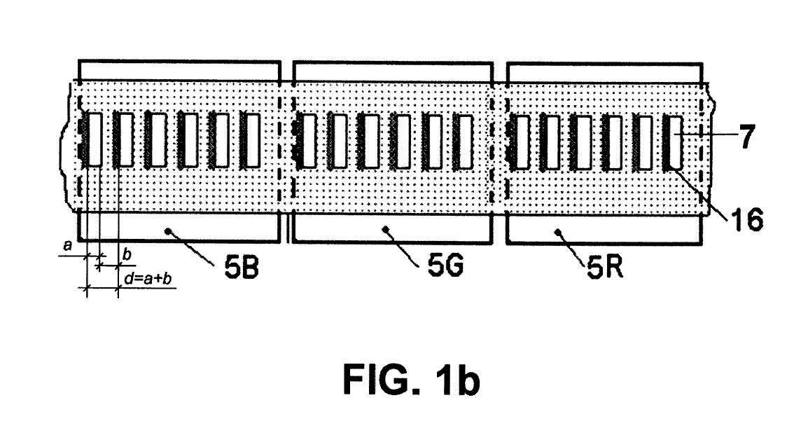

Turning now to FIG. 1a, a pixel of a liquid crystal display according to an embodiment of the present invention is depicted. The pixel includes an LC layer 1 inserted between two transparent substrates 3 and 13. Transparent electrodes (ITO) 5 and 14 are provided on the transparent substrates 3 and 13 as shown. The transparent electrodes 5 and 14 are covered with alignment layers 6. In one embodiment, the alignment layers 6 are made from a polymer layer which was appropriately rubbed. In another embodiment, the alignment layers 6 are made from photopolymer capable of definitely aligning the LC layer after exposure to actinic radiation, as described in Berreman, “Solid Surface Shape and the Alignment of an Adjacent Nematic Liquid Crystal”, Phys. Rev. Lett., 28, pp.1683-1686 (1972), which is incorporated by reference herein in its entirety.

FIG. 1b depicts one of the transparent electrodes, transparent electrode 14, which is made in the form of the comb having rectangular windows 7. The width of the window 7 is a, and the distance between windows is b. Thus, the period of the comb-like structure is d, which is the sum of a and b. The alignment layer 6 is provided over the entire surface of the electrode 5, including over the windows 7. Additionally, on one edge 16 of each of the etched windows 7, local defects of initial orientation (in the LC layer upon application of a voltage) are generated by the electrode and alignment layer. An appropriate alignment layer can be produced according to various known alignment methods, for example, as described in Chigrinov, Liquid Crystal Devices: Physics and Applications, Artech-House, Boston-London (1999), Chapter 4.10 “1.4 Surface Phenomena and Cell Preparation”, pp. 53-64, which is incorporated by reference herein in its entirety. It will be appreciated that such an alignment does not affect the initial orientation of the LC when no voltage is present, but is capable of causing non-uniform orientation of the LC upon application of a control voltage.

The electrode 5 is divided into three areas, 5R, 5G, and 5B, each of which correspond to a sub-pixel and is used in generation of one primary color. The three sub-pixels make up a single pixel, which corresponds to one element of a color image. In each sub-pixel, the period of the combs is identical. A lenticular raster-condenser 8 and an input mask 9 with slits are provided on the outer side of the substrate 13 as shown in FIG. 1a. The distance between the flat side of the lenticular raster-condenser 8 and the input mask 9 is equal ƒc.

A lenticular raster-objective 10 and the output mask 15 with slits are placed on the outer side of the substrate 3. The output mask 15 is located in a focal plane of the lenticular raster-objective 10 (at a distance of ƒo from the flat side of the lenticular raster-objective). The slits of the output mask 15 are provided such that only they are arranged on only one side of the optical axis of each separate lens of the lenticular raster-objective 10 at a distance of l_{R}, l_{G}, and l_{B}, for each of colors R, G, and B, respectively. In the embodiment depicted by FIG. 1a, the slits are arranged to the right of the optical axis O-O of each sub-pixel (which is the optical axis of the lenticular raster-condensers 8 and the lenticular raster-objectives 10).

The present invention is based in part on the principle that the choice of a way of orientation of liquid crystal molecules is insignificant and a wide choice of methods of orientation is possible (e.g., rubbing, sputtering, photoalignment, etc.). Generally, regardless of the method of orientation, the initial orientation on the surface of the electrode (or on the electrode surface and the substrate surface if the electrode does not completely cover the substrate, e. g, when windows are etched in the electrode) is uniform. Thus, upon application of a control voltage, the LC corresponding to the electrode surface responds to the voltage uniformly. However, when an alignment layer is provided as described herein, local defects in initial orientation are introduced at the edges 16 of one side of each of the windows 7 (as shown in FIG. 1b) upon the application of a control voltage, allowing a non-uniform LC orientation to be achieved.

The present invention is also based in part on the fact that a passive, uncontrollable reflective diffraction grating has a wedge-like profile of the refraction indexes. At a correctly chosen profile of the refraction indexes, grating in a reflective mode creates a unique spectrum of the 1st order. This is described as “echelette” in Kaporskii, The Great Soviet Encyclopedia, 3rd Edition (1970-1979) (“Echelette”), which is incorporated herein by reference in its entirety. An “echelette” type grating utilizes non-uniform distribution of indices of refraction (e.g., wedge-shaped distribution) within one structural element (e.g., strip, stroke) of the grating. Kaporskii describes the grating in the context of a reflective mode, but embodiments of the present invention have applied these principles to design a similar grating for a liquid crystal device in transmission mode. The use of such an operated grating (i.e., a switchable active grating that can have two states: ON and OFF, unlike a passive grating that cannot be switched) allows the elimination of all other diffractive orders besides a first diffractive order.

As shown in FIG. 1a, rays of white non-polarized light 12 (axial and paraxial) illuminate the input mask 9. Narrow beams of the light pass through the slits of the input mask 9. As the slits of the input mask 9 coincide with foci of the lenticular raster-condenser 8 on the exit of condenser 8, almost parallel (quasi-parallel) beams of light are formed which evenly illuminate the areas of the substrate 13 and transparent electrode 14 corresponding to each sub-pixel.

The lenticular raster-objective 10 generates an image of the light source (obtained through the slits of the input mask 9) in the focal plane of the lenticular raster-objective 10, i.e., on the output mask 15. Local defects in the initial orientation are introduced by the left edges 16 of the windows 7 shown in FIG. 1b.

In an initial state (without an applied control voltage), a bright white image is transmitted to the output mask on the optical axis O-O, the white image having 100% of the intensity of light provided to the sub-pixel. At the opaque sites of the output mask 15, all radiation is absorbed, resulting in the first optical state of the pixel: the DARK state.

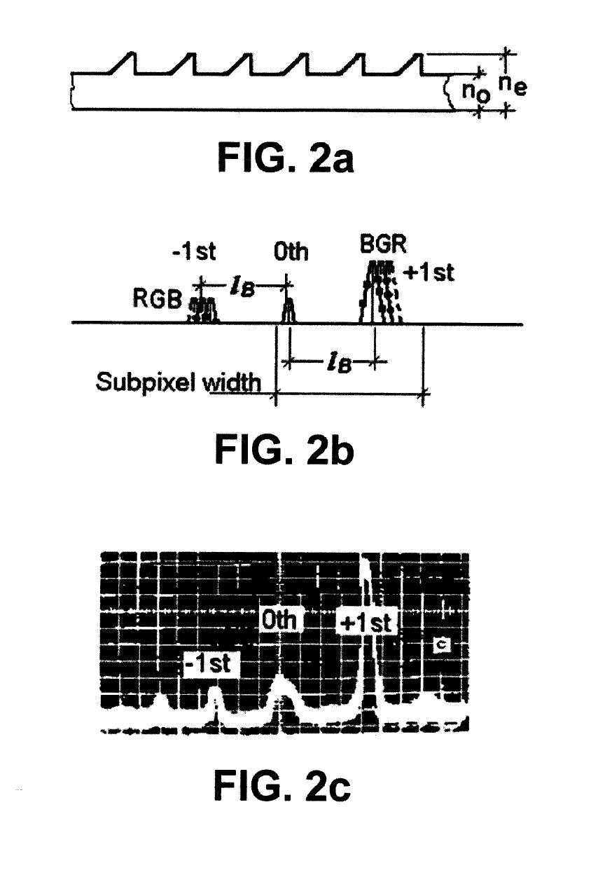

Upon application of a control voltage to the electrode 14, which causes defects in the initial orientation at the edges 16 of the windows 7, and to one or more sub-areas (5R, 5G, 5B) of the electrode 5, the LC layer of these sub-pixels creates a periodic system of sites with reoriented LC (in the gap between the windows) and LC with the initial orientation (within the windows). The system of sites with different orientations in the LC layer is the phase diffraction grating. The period of this system is d for all three sub-pixels. Due to the defects in the initial orientation, the diffraction grating has a wedge-shaped profile of refractive indices as shown in FIG. 2a. The white light passing through the phase diffraction grating with the refractive index profile shown in FIG. 2a forms systems of diffraction spectra of ±m orders in the plane of the output mask 15.

The angle with respect to the optical axis O-O at which light of a certain wavelength will pass through is governed by the expression:

sin φ=±m λ/d,

where φ is the angle at which light with the wavelength λ propagates, λ is the wavelength, m is the number corresponding to a diffraction peak (in the case, only positive integer values are used due to the wedge-shaped refractive index profile), and d is a period of the grating. Turning back to FIG. 1a, φ_{B} is the angle corresponding to blue color B, φ_{G} is the angle corresponding to green color G, and φ_{R} is the angle corresponding to red color R. It will be appreciated that in FIG. 1a, only the +1st order of the diffraction is depicted for simplicity (and because the other orders are absent or negligible).

In the locations at which each of the colors is focused at the output mask 15, the output mask 15 includes transparent regions, or slits, which are positioned so as to transmit light of only a given wavelength. In FIG. 1a, the distances from the central axis to the center of each of the slits are depicted as l_{R}, l_{G}, and l_{B}, respectively. For the transmission of the color R, the slit of the output mask is located at a distance l₄ from the central axis of the lens corresponding to that sub-pixel. For the transmission of the color G, the slit of the output mask is located at a distance l_{G} from the central axis of the lens corresponding to that sub-pixel. For the transmission of the color B, the slit of the output mask is located at a distance l_{B} from the central axis of the lens corresponding to that sub-pixel.

The spectral composition of light transmitted by the slits of the output mask 15 is determined by the position of the slits with respect to the center axes of each lens (which corresponds to the location of the slits of the input mask) and the width of the slits. These parameters are set structurally and are independent for each of colors. The parameters may be varied based on the requirements of a particular device. For example, if purer colors are desired, the width of the slits may be minimized, which also results in a relatively reduced intensity of light that is ultimately transmitted through the output mask. If a higher intensity is desired and relatively lower purity of color is acceptable, the slits width may be increased up to a size corresponding to one-third of the width of the entire spectrum of visible color.

A pixel designed according to the embodiments of the present invention described herein possesses four separate optical states: COLOR 1 (R Red), COLOR 2 (G Green), COLOR 3 (B Blue) and DARK state. These states can be combined in operation to obtain a full-color display having high performance parameters.

The amount of light of each wavelength ultimately transmitted through the entire pixel is defined by a diffractive efficiency of the gratings which, in turn, depends on the applied control voltage amplitude. Thus, the intensity of each sub-pixel can be modulated, and images involving the full color gamut or gray scale can be generated. Because of the absence of absorbing polarizers and optical filters, the efficiency, with respect to use of backlighting energy, of displays utilizing the structure of the present invention is high (up to 30-40%) relative to conventional displays (1-5%).

In an embodiment, applying a uniform voltage causes LC molecules in the area at the edges of the windows to be reoriented at first (producing the local defects in initial orientation), and then gradually, based on the voltage, the reorientation extends to all areas of the electrode over time. As a result of such reorientation, a phase diffractive grating is generated with a wedge-like profile of refraction indices as shown in FIG. 2a (analogous to the previously described uncontrollable diffractive grating “echelette”). Such profile of the refraction indices in the phase diffractive grating leads to an asymmetrical diffractive distribution at which the diffractive maxima on one side of the optical axis is less intense than the other side (or completely absent) at a correctly chosen geometry.

FIG. 2b shows a distribution of intensity of light at diffraction based on a phase grating with the profile of refraction indices depicted in FIG. 2a. An example of such a diffraction result obtained experimentally is further shown in the oscillogram of FIG. 2c. From the oscillogram it can be seen that the +1st diffractive order is well expressed, the zero-th order is insignificant, the −1st and −2nd orders are insignificant, and the +2nd order is practically absent. Furthermore, as shown in FIGS. 1d and 1e, the diffraction maxima on one side of the axis (the negative side) is almost absent or negligible.

In a first exemplary embodiment, an entire surface of a substrate and an electrode are covered with a layer of photopolymer capable, after exposure to actinic radiation, of targeting the adjacent LC molecules aligned in the same manner and of ensuring the uniform orientation of the entire field, as described in U.S. Pat. No. 6,582,776, issued Jun. 24, 2003 to Yip et al., which is incorporated herein by reference in its entirety.

This ability to align adjacent LC molecules is due to well-defined coupling energy and the angle of the anchoring of the LC molecules, which in turn depend on the exposure conditions. Depending on the coupling energy and the angle of the anchoring, the threshold voltage of the LCD response and the degree of deformation of the LC layer are different. Consequently, if, in the process of exposing, the local area exposure conditions are different from the remaining area, the local area will then be able to produce local defects in initial orientation. To obtain a diffraction pattern similar to the pattern shown in FIG. 2c, the photopolymer layer was exposed with actinic ultraviolet radiation of a first polarization. This first exposure was sufficient to provide satisfactory guidance for the entire area of the electrodes and the substrate. Then, a second exposure was made through a mask having a narrow (about 1 micron) gap, which coincides with an edge of each of the windows etched in the electrode.

The plane of polarization at the second exposure was changed to 10 degrees relative to the plane of polarization at the first exposure, and the duration of exposure was increased by a factor of two. As a result, the coupling energy and the anchoring angles in a narrow strip at the edge of the window have one value, while the rest of the entire area has another value. Initially, without the application of a control voltage, the entire area of the substrate and the narrow strip of double exposure do not differ in appearance.

After assembling the LC cell, an operating voltage is applied that is sufficient to trigger reorientation of the LC molecules in only the field of the double-exposed narrow strip. Then, increasing the voltage extends the operational area of the cell to the remaining single-exposed areas of the cell. Thus, the refractive index profile formed phase grating has a wedge-shaped profile in each strip, allowing a pronounced asymmetrical diffraction pattern to be obtained. Specific values of the modulation of the refractive indices in such grating and the intensity distribution of diffraction orders depend on the thickness of the LC, the form factor of the grating, visco-elastic properties of liquid crystals and many other factors. In any case, the geometry of the diffraction has a pronounced asymmetrical nature, which only uses half of the diffraction maxima (e.g., only the positive ones).

In a second exemplary embodiment, the entire surface of a substrate having an electrode with etched windows were coated the polymer layer (e.g., polyimide with a thickness of about 0.2 microns). Then using a stencil on one of the edges of the etched windows (width of about 1 micron), a narrow layer of another polymer was applied (e.g., polyvinyl alcohol with a thickness of about 0.2 microns). The polyimide layer and the polyvinyl alcohol layer have different coupling energy and different anchoring angles of the LC molecules. After assembling the LC cell with the substrate and the application of control voltage, reorientation of the LC under the narrow strip of polyvinyl alcohol is triggered first. By increasing the voltage range, the operation is shifted from only the narrow strip to the remaining areas as well. Thus, a wedge-like deformation of the LC layer is obtained, along with asymmetric diffraction and increased resolution.

It will be appreciated that the above-described embodiments are not limiting and that there are other methods of forming the initial orientation of the defects that contribute to inhomogeneous deformation of the LC.

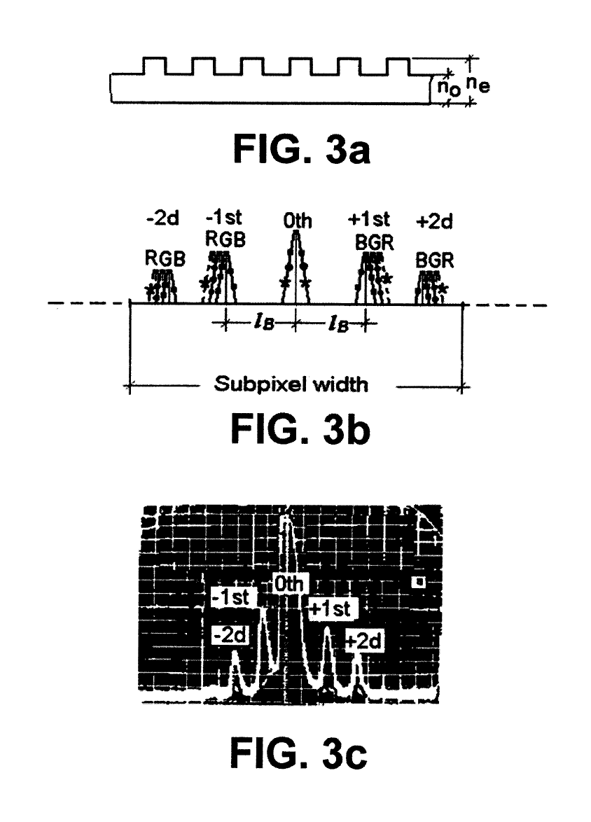

Relative to designs that utilizes homogenous deformation of the LC, such as the design described in RU Patent No. 2202817, issued Dec. 20, 2000, to Tsvetkov, which is incorporated by reference herein in its entirety, the resolution of displays according to embodiments of the present invention (which utilize inhomogenous deformation of the LC) are enhanced by at least a factor of two, since the width of pixels formed is at least two times smaller. The homogenous orientation of the LC layer in an interval between etched windows and the LC layer with initial orientation results in a phase diffractive grating with a meander-like profile of refraction indices as shown in FIG. 3a, which gives diffractive spectra of several orders as shown in FIG. 3b. For simplification and ease of understanding, only the ±1st and ±2nd orders are depicted in FIG. 3b. The proportion of the intensity corresponding to higher orders is generally insignificant. An oscillogram of experimentally obtained samples of spectra corresponding to the ±1st and ±2nd orders is depicted in FIG. 3c.

The problem with a display that corresponds to the diffractive spectra depicted in FIG. 3b is that the size of a pixel (i.e., its width) is based on utilizing an amount of diffractive peaks-maxima while minimizing error and without interfering with neighboring pixels. The diffractive grating used strictly defines the width of pixel, and consequently resolution of the display as a whole is predetermined. In order to reduce pixel width (and increase resolution), it is desirable to eliminate spectra from the left or right of the central axis. Thus, a diffraction distribution that includes ±1st and ±2nd orders as shown in FIG. 3b requires a much larger pixel size (at least two times) than a diffraction distribution that only includes the +1^{st} order as depicted by FIG. 2b.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A liquid crystal (LC) pixel, comprising:
a first electrode having comb-like structures;
an alignment layer adjacent to the first electrode, wherein the alignment layer is patterned with local areas that are different from the remaining area of the alignment layer and wherein the local areas are configured to produce local defects in initial orientation in an LC layer upon application of a control voltage; and
the LC layer, configured to asymmetrically diffract light passing through the LC layer based on configuration of the comb-like structures and the alignment layer.

2. The pixel of claim 1, wherein the comb-like structures of the first electrode are windows, and the local areas of the alignment layer are positioned at edges of the windows.

3. The pixel of claim 1, wherein the alignment layer is made of polymer and is aligned by rubbing.

4. The pixel of claim 1, wherein the alignment layer is made of photopolymer and is aligned by exposure to radiation.

5. The pixel of claim 1, wherein the local areas are exposed in a different manner from the remaining area.

6. The pixel of claim 5, wherein the local areas are double-exposed and the remaining area is single-exposed.

7. The pixel of claim 1, further comprising:
an input mask with slits;
a lenticular raster-condenser with foci that coincide with the slits of the input mask;
a lenticular raster-objective; and
an output mask with slits, wherein the position of the slits of the output mask is based on the position of the slits of the input mask.

8. The pixel of claim 6, wherein the pixel is divided into one or more sub-pixels, each of the sub-pixels corresponding to a different wavelength of light, and wherein the position of the slits of the output mask is based on the different wavelengths of light corresponding to the sub-pixels.

9. The pixel of claim 8, wherein the pixel is divided into three sub-pixels, each corresponding to a color.

10. A liquid crystal display device, comprising at least one liquid crystal (LC) pixel, wherein the at least one LC pixel comprises:
an input mask with slits;
a lenticular raster-condenser with foci that coincide with the slits of the input mask;
a first substrate;
a first electrode having comb-like structures;
an alignment layer adjacent to the first electrode, wherein the alignment layer is patterned with local areas that are different from the remaining area of the alignment layer and wherein the local areas are configured to produce local defects in initial orientation in an LC layer upon application of a control voltage;
the LC layer, configured to asymmetrically diffract light passing through the LC layer based on configuration of the comb-like structures and the alignment layer;
a second electrode;
a second substrate;
a lenticular raster-objective; and
an output mask with slits, wherein the position of the slits of the output mask is based on the position of the slits of the input mask,
wherein the at least one LC pixel is divided into one or more sub-pixels, and wherein the output mask is configured to transmit light from only one polarity of diffraction maxima of the diffracted light passing through the LC layer for each sub-pixel.

11. The liquid crystal display device of claim 10, wherein the at least one LC pixel is divided into three sub-pixels, each corresponding to a color.

12. A method for providing an output of a liquid crystal (LC) pixel having one or more sub-pixels, the method comprising:
receiving input light through slits of an input mask;
asymmetrically diffracting the input light at an LC layer based on application of a control voltage via an electrode having comb-like structures and local defects in orientation of the LC layer produced by the application of the control voltage and local areas of an alignment layer patterned differently than the remaining area of the alignment layer; and
providing the output through slits of an output mask.

13. The method of claim 12, wherein the slits are positioned so as to transmit light from only one diffraction maximum of the diffracted input light for each sub-pixel.

14. The method of claim 12, further comprising:
converting the input light to substantially parallel beams of light at a lenticular raster-condenser before diffracting the input light.

15. The method of claim 12, wherein the pixel is divided into three sub-pixels, each corresponding to a color.
